(19) United States
(12) Patent Application Publication
(10) Pub. No.: US 2026/0192688 A1
(43) Pub. Date: Jul. 9, 2026

(54) INTEGRATED CHASSIS FOR VOCATIONAL VEHICLES

(71) Applicant: Oshkosh Corporation, Oshkosh, WI (US)

(72) Inventors: Chad Smith, Oshkosh, WI (US); Simon Dean, Oshkosh, WI (US)

(73) Assignee: Oshkosh Corporation, Oshkosh, WI (US)

(21) Appl. No.: 19/438,882

(22) Filed: Jan. 2, 2026

Related U.S. Application Data
(60) Provisional application No. 63/741,560, filed on Jan. 3, 2025.

(51) Int. Cl. B60L 50/72

(52) U.S. Cl. CPC B60L 50/72; B60L 2200/36; B60L 2200/44

(57) ABSTRACT

A vehicle includes a chassis and a hydrogen-hybrid powertrain coupled to the chassis. The hydrogen-hybrid powertrain includes a hydrogen storage assembly supported on the chassis, a fuel cell connected to the hydrogen storage assembly, and one of: an energy storage device supported on the chassis, or a prime mover supported on the chassis and a transmission coupled to the prime mover. The hydrogen-hybrid powertrain selectively uses energy from one or more of the fuel cell, the energy storage device, or the prime mover to drive the vehicle.

### CROSS-REFERENCE TO RELATED PATENT APPLICATIONS

This application claims the benefit of and priority to U.S. Provisional Patent Application No. 63/741,560, filed Jan. 3, 2025, which is incorporated herein by reference in its entirety.

### BACKGROUND

Vocational vehicles typically include a chassis that supports various components on the vehicle.

### SUMMARY

In some aspects, the present disclosure relates to a vehicle including: a chassis; and a hydrogen-hybrid powertrain coupled to the chassis, the hydrogen-hybrid powertrain including: a hydrogen storage assembly supported on the chassis; a fuel cell connected to the hydrogen storage assembly; and one of: an energy storage device supported on the chassis; or a prime mover supported on the chassis and a transmission coupled to the prime mover; wherein the hydrogen-hybrid powertrain selectively receives energy from one or more of the fuel cell, the energy storage device, or the prime mover to drive the vehicle.

In some aspects, the present disclosure relates to a vehicle including: a chassis; and a hydrogen-hybrid powertrain coupled to the chassis, the hydrogen-hybrid powertrain including: a hydrogen storage assembly supported on the chassis; a fuel cell connected to the hydrogen storage assembly supported on the chassis; an energy storage device supported on the chassis; and an electric motor coupled to the fuel cell, wherein the hydrogen-hybrid powertrain selectively receives energy from the fuel cell and the energy storage device.

In some aspects, the present disclosure relates to a vehicle including: a chassis; and a hydrogen-hybrid powertrain coupled to the chassis, the hydrogen-hybrid powertrain including: a hydrogen storage assembly supported on the chassis; a fuel cell connected to the hydrogen storage assembly supported on the chassis; an internal combustion engine supported on the chassis; and an electric motor coupled to the fuel cell, wherein the hydrogen-hybrid powertrain selectively receives energy from the fuel cell and the internal combustion engine.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a left side view of a vehicle, according to an exemplary embodiment;

FIG. 2 is a perspective view of the vehicle of FIG. 1 configured as a refuse vehicle, according to an exemplary embodiment;

FIG. 3 is a perspective view of the vehicle of FIG. 1 configured as a mixer vehicle, according to an exemplary embodiment;

FIG. 4 is a perspective view of the vehicle of FIG. 1 configured as a fire fighting vehicle, according to an exemplary embodiment;

FIG. 5 is a left side view of the vehicle of FIG. 1 configured as an airport fire fighting vehicle, according to an exemplary embodiment;

FIG. 6 is a perspective view of the vehicle of FIG. 1 configured as a boom lift, according to an exemplary embodiment;

FIG. 7 is a perspective view of the vehicle of FIG. 1 configured as a scissor lift, according to an exemplary embodiment;

FIG. 8 is a rear perspective view of the vehicle of FIG. 1 configured as a delivery vehicle, according to an exemplary embodiment;

FIG. 9 is a perspective view of the vehicle of FIG. 1 configured as a military vehicle, according to an exemplary embodiment;

FIG. 10 is a perspective view of a frame or chassis assembly of the vehicle of FIG. 9, according to an exemplary embodiment;

FIG. 11 is a bottom perspective view of a vehicle including a hydrogen-hybrid powertrain, according to an exemplary embodiment;

FIG. 12 is a diagram of the hydrogen-hybrid powertrain of FIG. 11, according to an exemplary embodiment;

FIG. 13 is a diagram of the hydrogen powertrain, according to an exemplary embodiment;

FIG. 14 is a diagram of the hydrogen powertrain, according to another exemplary embodiment;

FIG. 15 is a diagram of the hydrogen-hybrid powertrain, according to an exemplary embodiment;

FIG. 16 is a diagram of the hydrogen powertrain, according to another exemplary embodiment;

FIG. 17 is a diagram of the hydrogen powertrain, according to another exemplary embodiment;

FIG. 18 is a diagram of the hydrogen powertrain, according to another exemplary embodiment; and

FIG. 19 is a diagram of the hydrogen powertrain, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, various types of powertrains are configured for use with a chassis of a vehicle. In an exemplary embodiment, a vehicle includes a chassis, and a hydrogen-hybrid powertrain coupled to the chassis. The hydrogen hybrid powertrain includes a hydrogen storage assembly positioned at a front end of the vehicle, and a fuel cell connected to and positioned rearward of the hydrogen storage assembly. The hydrogen-hybrid further includes an energy storage device positioned rearward of the fuel cell, where the energy storage device is configured to store energy. The hydrogen-hybrid powertrain further includes a transmission positioned rearward from the energy storage device and connected to the energy storage device and the fuel cell, and a primary driver connected to and positioned rearward from the transmission. The hydrogen-hybrid powertrain selectively uses energy from one or more of the fuel cell, the energy storage device, or the primary driver to drive the vehicle.

The various types of powertrains, including the hydrogen-hybrid powertrain, provide the advantage of enabling long range, high duty cycle, and clean energy usage in powertrain applications. For example, the hydrogen-hybrid powertrain may be used in a vehicle for pickup and delivery applications. The applications may include autonomous vehicle applications.

### Vehicle

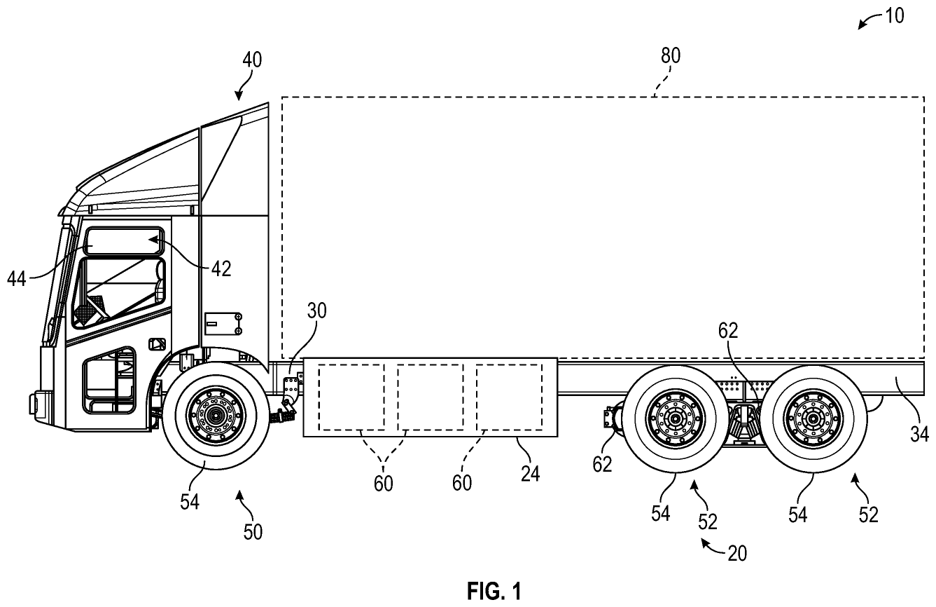

According to an exemplary embodiment, as shown in FIG. 1, an electrified vehicle (e.g., a vehicle assembly, a truck, a vehicle base, etc.), shown as vehicle 10, includes a frame assembly or chassis assembly, shown as chassis 20. The chassis assembly may support other components of the vehicle 10. In some embodiments, the chassis 20 extends longitudinally along a length of the vehicle 10. The chassis 20 may extend substantially parallel to a primary direction of travel of the vehicle 10. In some embodiments, the chassis 20 includes a middle section 24 that acts as a storage portion that includes one or more vehicle components. The middle section 24 may include an enclosure that contains one or more vehicle components and/or a frame that supports one or more vehicle components. In some embodiments, the middle section 24 contains or includes one or more electrical energy storage devices (e.g., batteries, capacitors, etc.).

According to an exemplary embodiment, a cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42 that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. In one embodiment, the cab interior 42 contains components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

According to an exemplary embodiment, the vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. In one embodiment, the vehicle 10 includes a tag axle that may be raised or lowered to accommodate variations in weight being carried by the vehicle 10. The front axle 50 and the rear axles 52 each include a plurality of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 10.

In some embodiments, the vehicle 10 is configured as an electric vehicle that is propelled by an electric powertrain system. As shown in FIG. 1, the vehicle 10 includes one or more electrical energy storage devices (e.g., batteries, battery packs, battery cells, capacitors, etc.), shown as batteries 60. As shown, the batteries 60 are supported on the chassis 20 (e.g., between the frame rails of the chassis 20). In other embodiments, the batteries 60 are otherwise positioned throughout the vehicle 10. The vehicle 10 further includes one or more electromagnetic devices (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 54 and provide electrical energy to the batteries 60, providing a braking force to slow the vehicle 10. As shown, the drive motors 62 are positioned within the rear axles 52 (e.g., as part of a combined axle and motor assembly). In other embodiments, the drive motors 62 are otherwise positioned within the vehicle 10 or within the axle assemblies.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system includes a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 is further be configured to support non-hybrid powertrains. For example, the powertrain system may include a primary driver that is a compression-ignition internal combustion engine that utilizes diesel fuel.

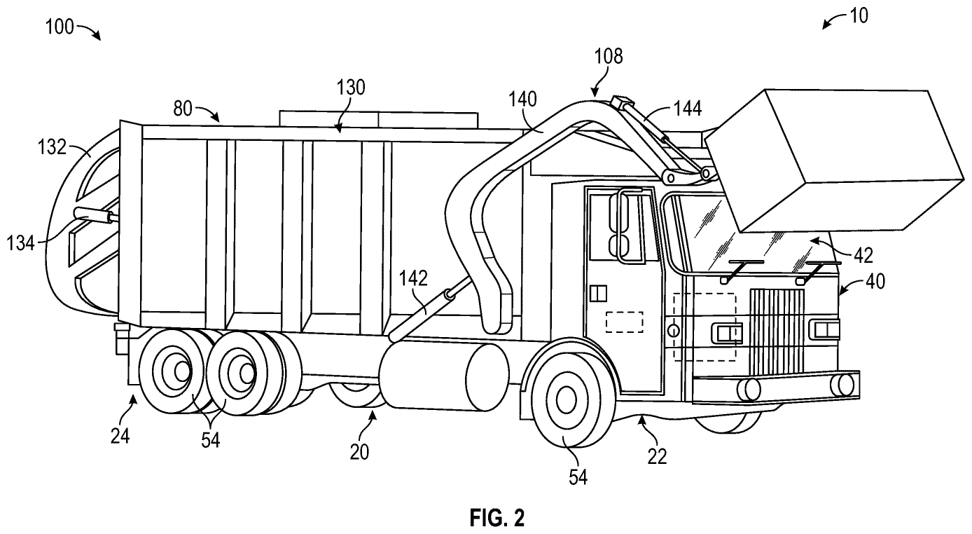

As shown in FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 2-7 illustrate various examples of how the vehicle 10 may be configured for specific applications. Although only a certain set of vehicle configurations is shown, it should be understood that the vehicle 10 may be configured for use in other applications that are not shown.

According to an exemplary embodiment, the application kit 80 includes various actuators to facilitate certain functions of the vehicle 10. In one embodiment, the application kit 80 includes hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. In another embodiment, the application kit 80 includes hydraulic or pneumatic components that form a hydraulic or pneumatic circuit (e.g., conduits, valves, pumps, compressors, gauges, reservoirs, accumulators, etc.). By way of another embodiment, the application kit 80 includes electrical components (e.g., batteries, capacitors, voltage regulators, motor controllers, etc.). The actuators may be powered by components of the vehicle 10. In some embodiments, the actuators are powered by the batteries 60, the drive motors 62, or the primary driver (e.g., through a power take off).

As shown in FIG. 2, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a side-loading refuse vehicle.

As shown in FIG. 2, the application kit 80 of the refuse vehicle 100 includes a rear body or container, shown as refuse compartment 130, and a pivotable rear portion, shown as tailgate 132. The refuse compartment 130 may facilitate transporting refuse from various waste receptacles within a municipality to a storage and/or a processing facility (e.g., a landfill, an incineration facility, a recycling facility, etc.). According to an exemplary embodiment, loose refuse is placed into the refuse compartment 130 to be compacted. The refuse compartment 130 may also provide temporary storage for refuse during transport to a waste disposal site and/or a recycling facility. In some embodiments, the refuse compartment 130 includes a hopper volume and storage volume. In this regard, refuse may be initially loaded into the hopper volume and later compacted into the storage volume. According to an exemplary embodiment, the hopper volume is positioned between the storage volume and the cab 40 (e.g., refuse is loaded into a position of the refuse compartment 130 behind the cab 40 and stored in a position further toward the rear of the refuse compartment 130). In other embodiments, the storage volume is positioned between the hopper volume and the cab 40 (e.g., in a rear-loading refuse truck, etc.). The tailgate 132 may be pivotally coupled to the refuse compartment 130, and may be movable between a closed position and an open position by an actuator (e.g., a hydraulic cylinder, an electric linear actuator, etc.), shown as tailgate actuator 134 (e.g., to facilitate emptying the storage volume).

As shown in FIG. 2, the refuse vehicle 100 also includes an implement, shown as lift assembly 108 (e.g., a front-loading lift assembly, etc.). According to an exemplary embodiment, the lift assembly 108 includes a pair of lift arms 140, lift arm actuators 142, and articulation actuators 144. The lift arms 140 may be rotatably coupled to the chassis 20. In another embodiment, the lift arms 140 are rotatably coupled to the refuse compartment 30 on each side of the refuse vehicle 100 (e.g., through a pivot, a lug, a shaft, etc.). Such an embodiment provides that the lift assembly 108 extends forward relative to the cab 40 (e.g., a front-loading refuse truck, etc.). In other embodiments, the lift assembly 108 extends rearward relative to the application kit 80 (e.g., a rear-loading refuse truck). In yet other embodiments, the lift assembly 108 extends from a side of the application kit 80 (e.g., a side-loading refuse truck). The lift arm actuators 142 are positioned such that extension and retraction of the lift arm actuators 142 rotates the lift arms 140 about an axis extending through the pivot. In this regard, the lift arms 140 may be rotated by the lift arm actuators 142 to lift a refuse container over the cab 40. In an exemplary embodiment, the articulation actuators 144 are positioned to articulate the distal end of the lift arms 140 (e.g., a portion of the lift arms 140 that may be coupled to the refuse container) in order to assist in tipping refuse out of the refuse container and into the refuse compartment 130. The lift arm actuators 142 may then rotate the lift arms 140 to return the empty refuse container to the ground.

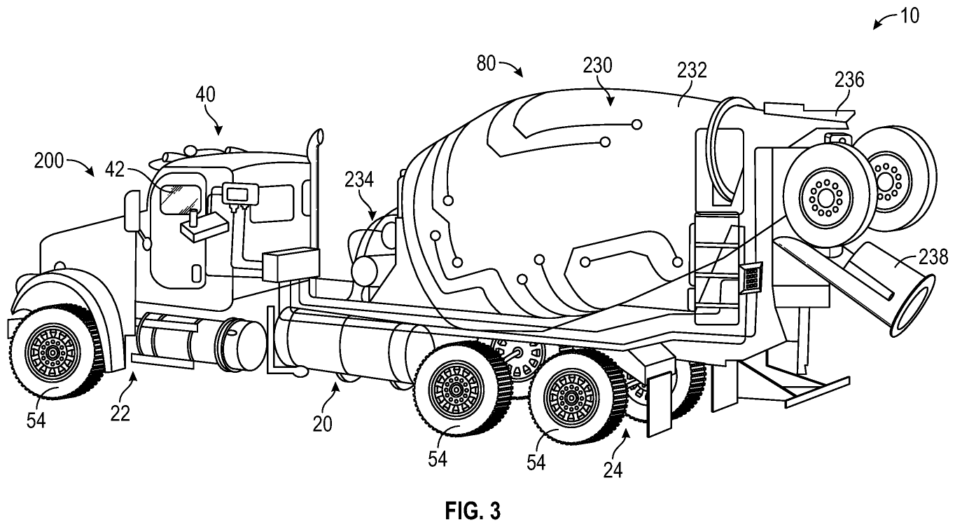

According to another exemplary embodiment, as shown in FIG. 3, the vehicle 10 is configured as a mixer truck (e.g., a concrete mixer truck, a mixer vehicle, etc.), shown as mixer truck 200. Specifically, the mixer truck 200 is a rear-discharge concrete mixer truck. In other embodiments, the mixer truck 200 is a front-discharge concrete mixer truck.

As shown in FIG. 3, the application kit 80 includes a mixing drum assembly (e.g., a concrete mixing drum), shown as drum assembly 230. The drum assembly 230 includes a mixing drum 232, a drum drive system 234 (e.g., a rotational actuator or motor), an inlet, shown as hopper 236, and an outlet, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 is elevated from the chassis 20 (e.g., from a horizontal plan extending along the chassis 20) at an angle in the range of five degrees to twenty degrees. In other embodiments, the central, longitudinal axis is elevated by less than five degrees (e.g., four degrees, etc.). In yet another embodiment, the mixer truck 200 includes an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves). The injection system may include an injection valve that selectively fluidly couples a supply of fluid to the inner volume of the mixing drum 232. In one embodiment, the injection system is used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) are positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 includes an actuator positioned such that the chute 238 may be selectively pivotable to position the chute 238 (e.g., vertically, laterally, etc.), for example, at an angle at which the mixture is expelled from the mixing drum 232.

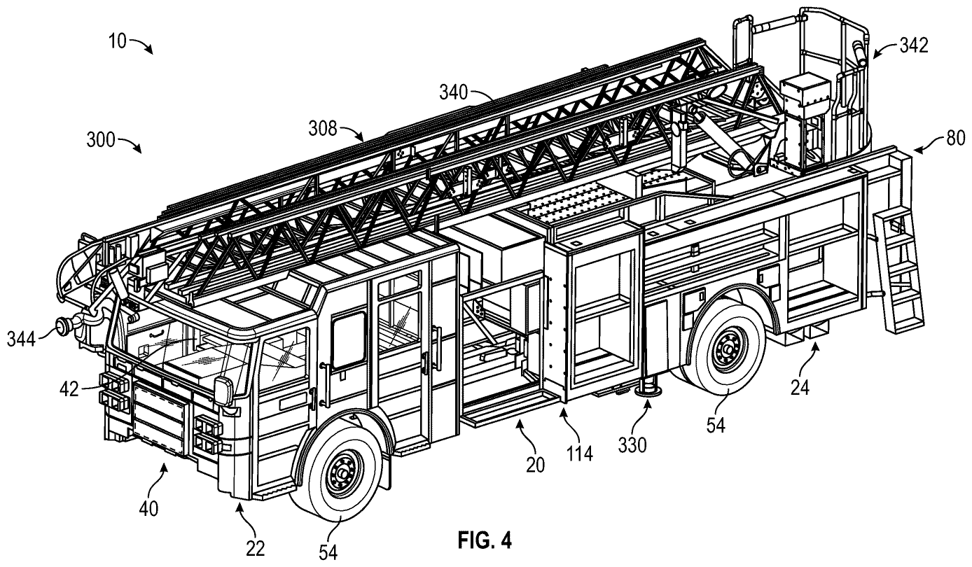

As shown in FIG. 4, the vehicle 10 is configured as a fire fighting vehicle or fire apparatus (e.g., a turntable ladder truck, a pumper truck, a quint, etc.), shown as fire fighting vehicle 300. As shown in FIG. 4, the fire fighting vehicle 300 is configured as a rear-mount aerial ladder truck. In other embodiments, the fire fighting vehicle 300 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. According to an exemplary embodiment, the vehicle 10 is be configured as a police vehicle, an ambulance, a tow truck, or still other vehicles used for responding to a scene (e.g., an accident, a fire, an incident, etc.).

As shown in FIG. 4, in the fire fighting vehicle 300, the application kit 80 is positioned mainly rearward from the cab 40. The application kit 80 includes deployable stabilizers (e.g., outriggers, downriggers, etc.), shown as outriggers 330, that are coupled to the chassis 20. The outriggers 330 may be configured to selectively extend from each lateral side and/or the rear of the fire fighting vehicle 300 and engage a support surface (e.g., the ground) in order to provide increased stability while the fire fighting vehicle 300 is stationary. This increased stability is desirable when the ladder assembly 308 is in use (e.g., extended from the fire fighting vehicle 300) to prevent tipping. In some embodiments, the application kit 80 further includes various storage compartments (e.g., cabinets, lockers, etc.) that are selectively opened and/or accessed for storage and/or component inspection, maintenance, and/or replacement.

As shown in FIG. 4, the application kit 80 includes a ladder assembly 308 coupled to the chassis 20. The ladder assembly 308 includes a series of ladder sections 340 that are slidably coupled with one another such that the ladder sections 340 may extend and/or retract (e.g., telescope) relative to one another to selectively vary a length of the ladder assembly 308. A base platform, shown as turntable 342, is rotatably coupled to the chassis 20 and to a proximal end of a base ladder section 340 (i.e., the most proximal of the ladder sections 340). The turntable 342 may be configured to rotate about a vertical axis relative to the chassis 20 to rotate the ladder sections 340 about the vertical axis (e.g., up to 360 degrees, etc.). The ladder sections 340 may rotate relative to the turntable 342 about a substantially horizontal axis to selectively raise and lower the ladder sections 340 relative to the chassis 20. As shown, a water turret or implement, shown as monitor 344, is coupled to a distal end of a fly ladder section 340 (i.e., the most distal of the ladder sections 340). The monitor 344 may be configured to expel water and/or a fire suppressing agent (e.g., foam, etc.) from a water storage tank and/or an agent tank onboard the fire fighting vehicle 300, and/or from an external source (e.g., a fire hydrant, a separate water/pumper truck, etc.). In some embodiments, the ladder assembly 308 further includes an aerial platform coupled to the distal end of the fly ladder section 340 and configured to support one or more operators.

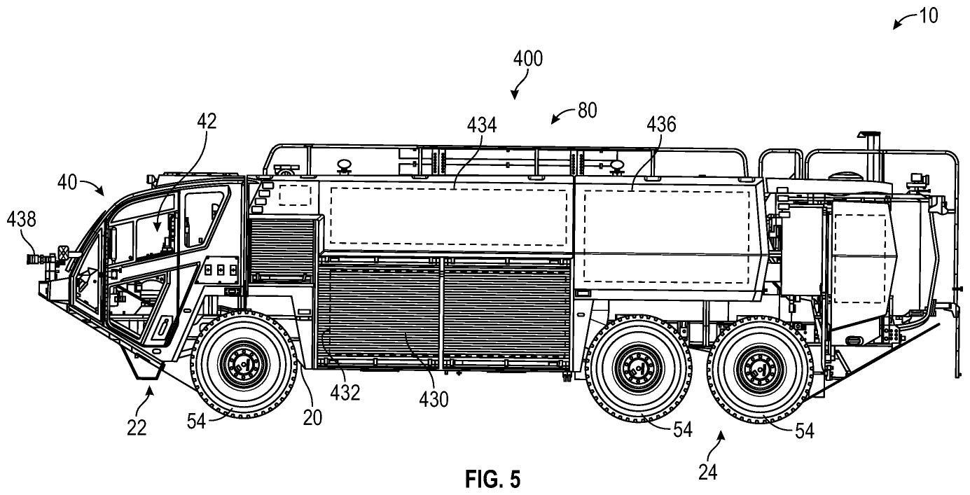

According to another exemplary embodiment, as shown in FIG. 5, the vehicle 10 is configured as a fire fighting vehicle, shown as airport rescue and fire fighting (ARFF) truck 400. As shown in FIG. 5, the application kit 80 is positioned primarily rearward of the cab 40. As shown, the application kit 80 includes a series of storage compartments or cabinets, shown as compartments 430, that are coupled to the chassis 20. The compartments 430 may store various equipment or components of the ARFF truck 400.

The application kit 80, as shown in FIG. 5, includes a pump system 432 (e.g., an ultra-high-pressure pump system, etc.) positioned within one of the compartments 430 near the center of the ARFF truck 400. The application kit 80 further includes a water tank 434, an agent tank 436, and an implement or water turret, shown as monitor 438. The pump system 432 may include a high pressure pump and/or a low pressure pump, which may be fluidly coupled to the water tank 434 and/or the agent tank 436. The pump system 432 may to pump water and/or fire suppressing agent from the water tank 434 and the agent tank 436, respectively, to the monitor 438. The monitor 438 may be selectively reoriented by an operator to adjust a direction of a stream of water and/or agent. As shown in FIG. 5, the monitor 438 is coupled to a front end of the cab 40.

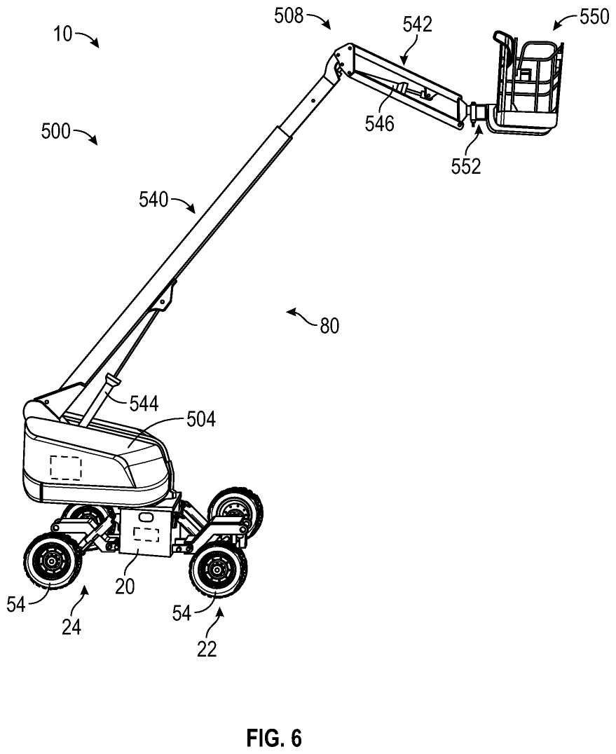

As shown in FIG. 6, the vehicle 10 is configured as a lift device, shown as boom lift 500. The boom lift 500 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 6, the application kit 80 includes a base assembly, shown as turntable 504 that is rotatably coupled to the chassis 20. The turntable 504 may be configured to selectively rotate relative to the chassis 20 about a substantially vertical axis. In some embodiments, the turntable 504 includes a counterweight positioned near the rear of the turntable 504. The turntable 504 is rotatably coupled to a lift assembly, shown as boom assembly 508. The boom assembly 508 includes a first section or telescoping boom section, shown as lower boom 540. The lower boom 540 includes a series of nested boom sections that extend and retract (e.g., telescope) relative to one another to vary a length of the boom assembly 508. The boom assembly 508 further includes a second boom section or four bar linkage, shown as upper boom 542. The upper boom 542 may include structural members that rotate relative to one another to raise and lower a distal end of the boom assembly 508. In other embodiments, the boom assembly 508 includes more or fewer boom sections (e.g., one, three, five, etc.) and/or a different arrangement of boom sections.

As shown in FIG. 6, the boom assembly 508 includes a first actuator, shown as lower lift cylinder 544. The lower boom 540 is pivotally coupled (e.g., pinned, etc.) to the turntable 504 at a joint or lower boom pivot point. The lower lift cylinder 544 (e.g., a pneumatic cylinder, an electric actuator, a hydraulic cylinder, etc.) is coupled to the turntable 504 at a first end and coupled to the lower boom 540 at a second end. The lower lift cylinder 544 may be configured to raise and lower the lower boom 540 relative to the turntable 504 about the lower boom pivot point.

The boom assembly 508 further includes a second actuator, shown as upper lift cylinder 546. The upper boom 542 is pivotally coupled (e.g., pinned) to the upper end of the lower boom 540 at a joint or upper boom pivot point. The upper lift cylinder 546 (e.g., a pneumatic cylinder, an electric actuator, a hydraulic cylinder, etc.) is coupled to the upper boom 542. The upper lift cylinder 546 may be configured to extend and retract to actuate (e.g., lift, rotate, elevate, etc.) the upper boom 542, thereby raising and lowering a distal end of the upper boom 542.

As shown in FIG. 6, the application kit 80 further includes an operator platform, shown as platform assembly 550, coupled to the distal end of the upper boom 542 by an extension arm, shown as jib arm 552. The jib arm 552 may be configured to pivot the platform assembly 550 about a lateral axis (e.g., to move the platform assembly 550 up and down, etc.) and/or about a vertical axis (e.g., to move the platform assembly 550 left and right, etc.).

According to an exemplary embodiment, the platform assembly 550 provides a platform configured to support one or more operators or users. In some embodiments, the platform assembly 550 includes accessories or tools configured for use by the operators. In one embodiment, the platform assembly 550 includes pneumatic tools (e.g., an impact wrench, airbrush, nail gun, ratchet, etc.), plasma cutters, welders, spotlights, etc. In other embodiments, the platform assembly 550 includes a control panel (e.g., a user interface, a removable or detachable control panel, etc.) configured to control operation of the boom lift 500 (e.g., the turntable 504, the boom assembly 508, etc.) from the platform assembly 550 or remotely. In other embodiments, the platform assembly 550 is omitted, and the boom lift 500 includes an accessory and/or tool (e.g., forklift forks, etc.) coupled to the distal end of the boom assembly 508.

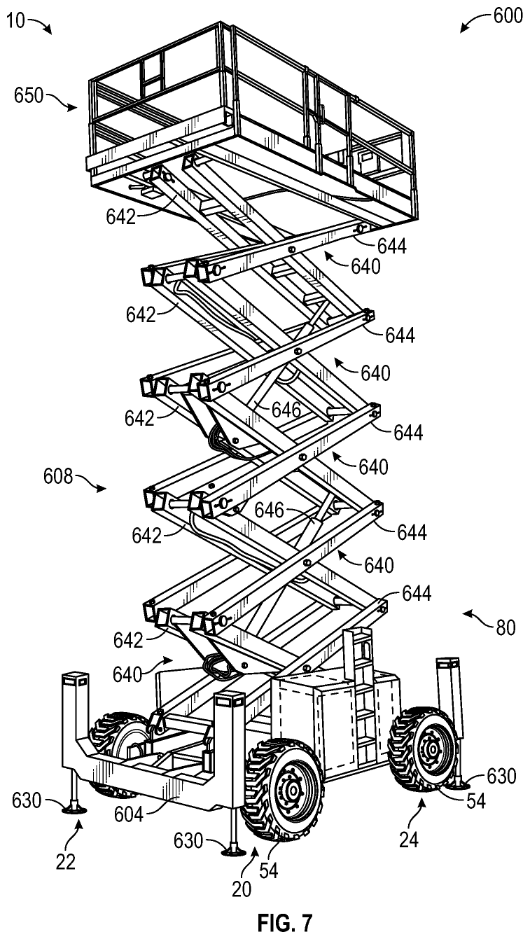

According to an exemplary embodiment, as shown in FIG. 7, the vehicle 10 is configured as a lift device, shown as scissor lift 600. As shown in FIG. 7, the application kit 80 includes a body, shown as lift base 604, coupled to the chassis 20. The lift base 604 is coupled to a scissor assembly, shown as lift assembly 608, such that the lift base 604 supports the lift assembly 608. The lift assembly 608 is configured to extend and retract, raising and lowering between a raised position and a lowered position relative to the lift base 604.

As shown in FIG. 7, the lift base 604 includes a series of actuators, stabilizers, downriggers, or outriggers, shown as leveling actuators 630. The leveling actuators 630 may extend and retract vertically between a stored position and a deployed position. In the stored position, the leveling actuators 630 may be raised, such that the leveling actuators 630 do not contact the ground. Conversely, in the deployed position, the leveling actuators 630 may engage the ground to lift the base assembly 604. The length of each of the leveling actuators 630 in their respective deployed positions may be varied in order to adjust the pitch (e.g., rotational position about a lateral axis) and the roll (e.g., rotational position about a longitudinal axis) of the base assembly 604 and/or the chassis 20. Accordingly, the lengths of the leveling actuators 630 in their respective deployed positions may be adjusted to level the base assembly 604 with respect to the direction of gravity (e.g., on uneven, sloped, pitted, etc. terrain). The leveling actuators 630 may lift the wheel and tire assemblies 54 off of the ground to prevent movement of the scissor lift 600 during operation. In other embodiments, the leveling actuators 630 are omitted.

According to an exemplary embodiment, the lift assembly 608 includes a series of subassemblies, shown as scissor layers 640, each including a pair of inner members 642 and a pair of outer members 644. The scissor layers 640 may be stacked atop one another in order to form the lift assembly 608. The inner members 642 may be pivotally coupled to the outer members 644 near the center of both the inner members 642 and the outer members 644. In this regard, the inner members 642 may pivot relative to the outer members 644 about a lateral axis. Each of the inner members 642 and the outer members 644 may include a top end and a bottom end. The bottom end of each inner member 642 may be pivotally coupled to the top end of the outer member 644 immediately below it, and the bottom end of each outer member 644 may be pivotally coupled to the top end of the inner member immediately below it. Accordingly, each of the scissor layers 640 may be coupled to one another such that movement of one scissor layer 640 causes a similar movement in all of the other scissor layers 640. The bottom ends of the inner member 642 and the outer member 644 that make up the lowermost scissor layer 640 may be coupled to the base assembly 604. The top beds of the inner member 642 and the outer member 644 that make up the uppermost scissor layer 640 may be coupled to the platform assembly 650. In some embodiments, scissor layers 640 may be added to, or removed from, the lift assembly 608 in order to increase, or decrease, the fully extended height of the lift assembly 608.

As shown in FIG. 7, the lift assembly 608 also includes one or more lift actuators 646 (e.g., hydraulic cylinders, pneumatic cylinders, motor-driven leadscrews, etc.) configured to extend and retract the lift assembly 608. The lift actuators 646 may be pivotally coupled to an inner member 642 at a fist end and pivotally coupled to an inner member 642 of another scissor layer 640 at a second end. In an exemplary embodiment, these inner members 642 belong to a first scissor layer 640 and a second scissor layer 640 (which may be separated by a third scissor layer 640). In other embodiments, the lift actuators 646 are arranged in other configurations (e.g., the first scissor layer 640 and the second scissor layer 640 are not separated by a third scissor layer 640, etc.).

According to an exemplary embodiment, as distal or upper end of the lift assembly 608 is coupled to an operator platform, shown as platform assembly 650. The lift actuators 646 may be configured to actuate the lift assembly 608 to selectively reposition the platform assembly 650 between a lowered position (e.g., where the platform assembly 650 is proximate to the lift base 604) and a raised position (e.g., where the platform assembly 650 is at an elevated height relative to the lift base 604). Specifically, in some embodiments, extension of the lift actuators 646 moves the platform assembly 650 upward (e.g., extending the lift assembly 608), and retraction of the lift actuators 646 moves the platform assembly 650 downward (e.g., retracting the lift assembly 608). In other embodiments, extension of the lift actuators 646 retracts the lift assembly 608, and retraction of the lift actuators 646 extends the lift assembly 608. In some embodiments, the outer members 644 are parallel to and/or in contact with one another when the lift assembly 608 is in the stored position.

In some embodiments, the platform assembly 650 includes a platform that is configured to support one or more operators or users. Similar to the platform assembly 550, the platform assembly 650 may include accessories or tools (e.g., pneumatic tools, plasma cutters, welders, spotlights, etc.) configured for use by an operator. The platform assembly 650 may include a control panel to control operation of the scissor lift 600.

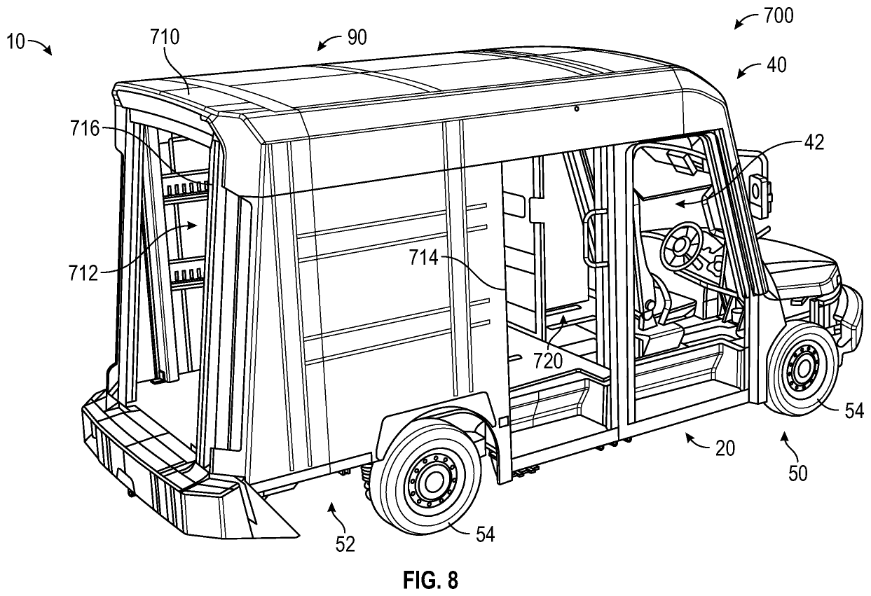

As shown in FIG. 8, the vehicle 10 is configured as a delivery vehicle 700 (e.g., a parcel vehicle, a cargo transport vehicle, a mail vehicle, a postal vehicle, a postal van, a truck, a van, etc.). Specifically, the delivery vehicle 700 is a delivery vehicle with a hatch door. In other embodiments, the delivery vehicle 700 does not include a hatch door.

As shown in FIG. 8, the application kit 90 includes a rear storage section, shown as cargo body 710. The cargo body 710 defines an interior section or zone, shown as cargo compartment 712, a first opening, shown as side cargo opening 714, and a second opening, shown as rear cargo opening 716. The side cargo opening 714 is positioned along a right side of the of the delivery vehicle 700 and facilitates ingress into and egress from the cargo compartment 712 from the right side of the delivery vehicle 700. The rear cargo opening 716 is positioned at a rear end of the delivery vehicle 700 and facilitates ingress into and egress from the cargo compartment 712 from the rear end of the delivery vehicle 700. The cargo compartment 712 is configured to receive and store parcels (e.g., mail, packages, etc.) for transport and delivery via the delivery vehicle 700. In some embodiments, the cargo compartment 712 includes cabinets, shelves, racks, and/or other storage devices to facilitate organizing and securing the parcels within the cargo compartment 712.

As shown in FIG. 8, the application kit 90 defines an opening, shown as passageway 720, that connects the cab interior 42 to the cargo compartment 712. In some embodiments, the application kit 90 includes a door or gate that at least partially and selectively encloses the passageway 720. In other embodiments, the application kit 90 includes a full partition that completely segregates the cab interior 42 from the cargo compartment 712.

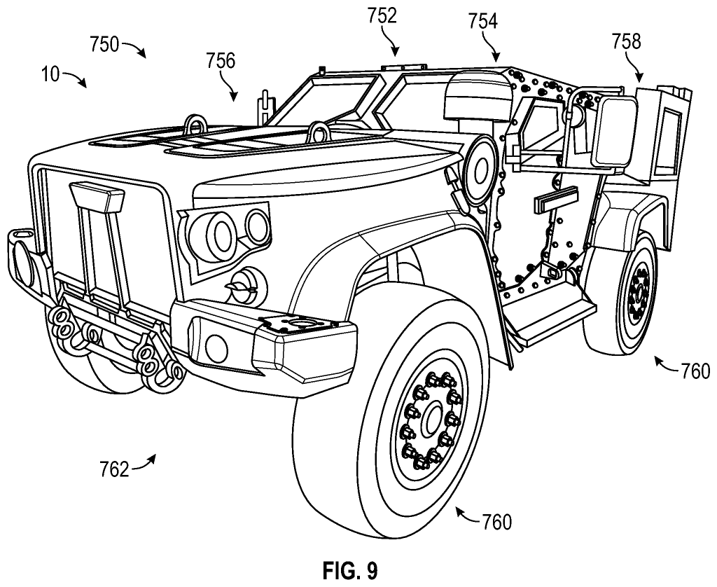

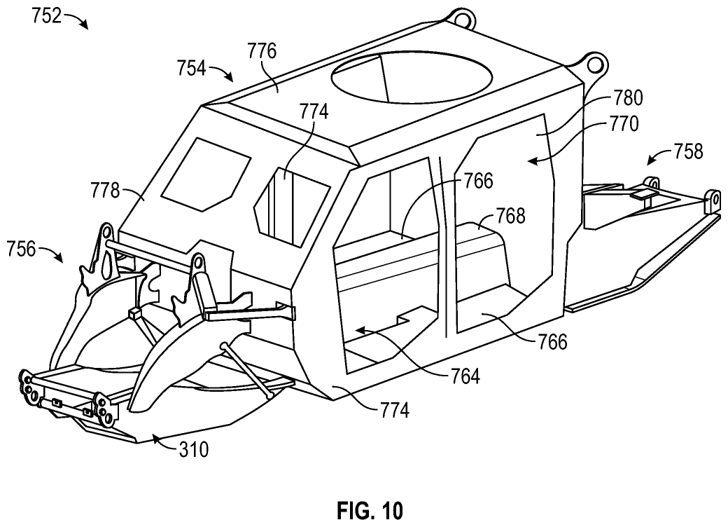

According to an exemplary embodiment, as shown in FIGS. 9 and 10, the vehicle 10 is configured as a military vehicle 750. In the embodiment shown, the military vehicle 750 is a joint light tactical vehicle (“JLTV”). In other embodiments, the military vehicle 750 is another type of military vehicle (e.g., a medium tactical vehicle, a heavy tactical vehicle, etc.).

The vehicle 10 includes a chassis assembly, shown as hull and frame assembly 752, including a passenger cabin, shown as passenger capsule 754, a first module, shown as front module 756, a second module, shown as rear module 758; a plurality of axle assemblies (e.g., including axles, differentials, wheels or tractive elements, brakes, suspension components, etc.), shown as axle assemblies 760, coupled to the front module 756 and the rear module 758; and a first driveline arrangement (e.g., a powertrain, a drivetrain, including an accessory drive, etc.), shown as driveline 762.

According to an exemplary embodiment, the passenger capsule 754 is a structural shell that forms a monocoque hull structure. Monocoque refers to a form of vehicle construction in which the vehicle body and chassis form a single unit. In some embodiments, the passenger capsule 754 includes a plurality of integrated armor mounting points configured to engage a supplemental armor kit (e.g., a “B-Kit,” etc.). According to the exemplary embodiment, the passenger capsule 754 accommodates four passengers in a two-by-two seating arrangement and has four doors mounted thereto. According to the alternative embodiment, the passenger capsule 754 accommodates two passengers and has two doors mounted thereto.

The passenger capsule 754 includes a floor assembly, shown as floor assembly 764, having a pair of floor portions, shown as floor portions 766, laterally spaced apart and separated by a central tunnel, shown as structural tunnel 768, extending longitudinally along a centerline of the passenger capsule 754. According to an exemplary embodiment, for load purposes, the structural tunnel 768 replaces a frame or rail traditionally used in vehicle chassis. As shown in FIG. 10, the structural tunnel 768 (i) has an arcuately shaped cross-section that extends upward into an interior, shown as passenger compartment 770, of the passenger capsule 754 and (ii) defines a cavity, recessed space, or tunnel slot. The configuration of the passenger capsule 754 increases the distance between the ground and the passenger compartment 770 of the passenger capsule 754. The passenger capsule 754 additionally includes a pair of side panels, shown as sidewalls 774, coupled to opposing lateral sides of the floor assembly 764; a top panel, shown as roof 776, coupled to the sidewalls 774 opposite the floor assembly 764; a front panel, shown as front wall 778, coupled to front ends of the floor assembly 764, the sidewalls 774, and the roof 776; and a rear panel, shown as rear wall 780, coupled to rear ends of the floor assembly 764, the sidewalls 774, and the roof 776. The floor assembly 764, the sidewalls 774, the roof 776, the front wall 778, and the rear wall 780 cooperatively define the passenger compartment 770.

Some embodiments of the present disclosure relate to a vocational vehicle. A vocational vehicle refers to a vehicle used to perform one or more tasks related to an occupation in some embodiments. For example, a vocational vehicle may refer to a fire truck, a refuse vehicle, a military vehicle, etc. Embodiments of the present disclosure wherein the vehicle 10 is described as a vocational vehicle may have applications to a more general class of vehicles. Similarly, embodiments of the present disclosure where in the vehicle 10 is referred to as a general vehicle (e.g., not specifically described as a vocational vehicle or any other type of vehicle) should be interpreted as inclusive of vocational vehicles.

### Integrated Chassis

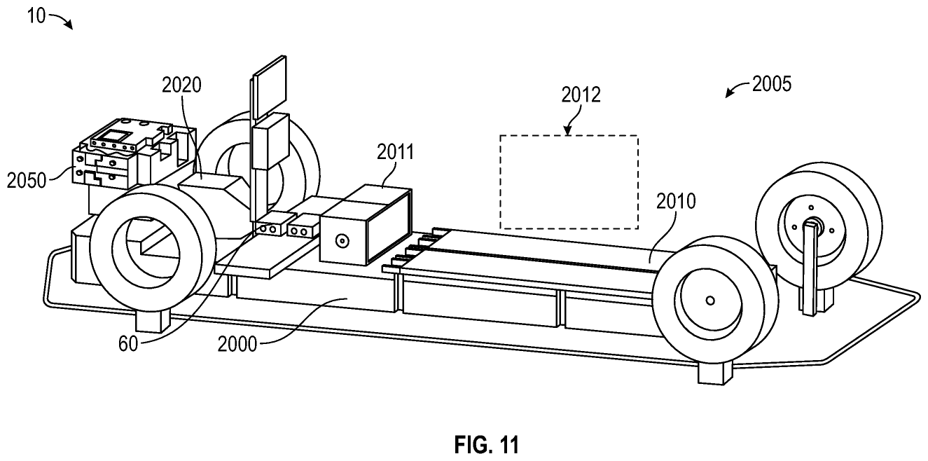

Referring to FIG. 11, the vehicle 10 includes a chassis 2000 configured to accommodate various types of powertrains (e.g., electric, fuel cell, hybrid and/or non-hybrid powertrains) coupled to the chassis 2000. The chassis 2000 may be configured similarly to the chassis 20, as described herein.

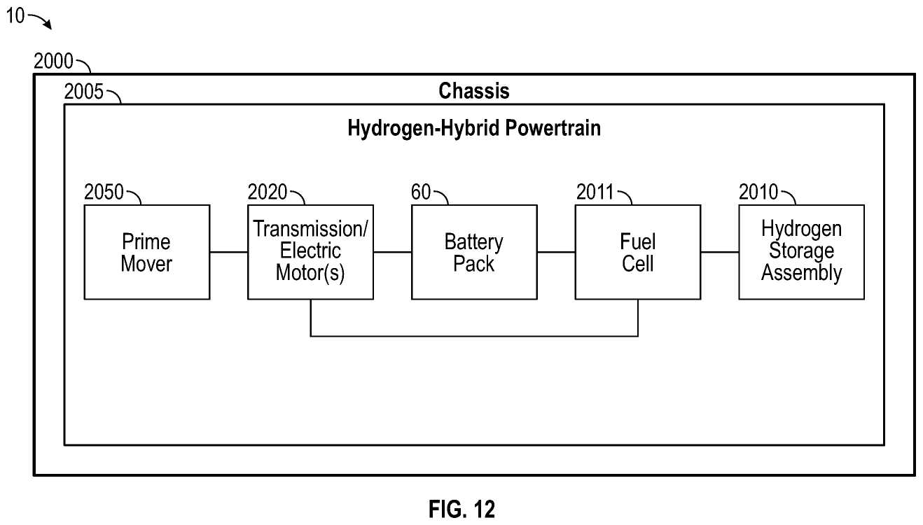

Referring to FIGS. 11 and 12, the vehicle 10 includes a hybrid powertrain, shown as hydrogen-hybrid powertrain 2005, where the hydrogen-hybrid powertrain 2005 includes a hydrogen storage assembly 2010 coupled to and positioned at a front end of the chassis 2000, and a fuel cell, shown as hydrogen fuel cell 2011, coupled to the chassis 2000 and positioned rearward of the hydrogen storage assembly 2010. The hydrogen fuel cell 2011 is fluidly connected to the hydrogen storage assembly 2010. The vehicle 10 further includes an energy storage device, shown as batteries 60, coupled to the chassis 2000 and positioned rearward of the hydrogen fuel cell 2011. The vehicle 10 further includes a transmission 2020 coupled to the chassis 2000 and positioned rearward of the batteries 60, and a prime mover 2050 (e.g., internal combustion engine, motor, etc.) positioned rearward of the transmission 2020, and configured to drive the vehicle 10. For example, the prime mover 2050 may be positioned at a rear end of the chassis 2000. The hydrogen fuel cell 2011 and/or the batteries 60 may be connected to the transmission 2020. In some embodiments, the hybrid powertrain may include fewer, additional, and/or a different arrangement of components for powering (e.g., driving) the vehicle 10. The components of the hybrid powertrain may be fastened (e.g., using fasteners, welded) to the chassis 2000. In some embodiments, the transmission 2020 is configured to drive a drive shaft that is couple to the wheels of the vehicle 10. In some embodiments, the transmission 2020 is in the form of an electric motor or electric motors that are powered by components of the powertrain 2005. In some embodiments, the electric motor(s) and/or the transmission (e.g., gear train) form part of an electronic axle (E-Axle).

Referring to FIG. 11, the vehicle 10 includes the hydrogen storage assembly 2010 coupled to the chassis 2000. The hydrogen storage assembly 2010 is positioned at a front end of the chassis 2000. The hydrogen storage assembly 2010 is configured as a flat pack, extending a longitudinal length along the chassis 2000. For example, a plurality of tubes (e.g., canisters) of hydrogen are arranged in parallel, extending along the chassis 2000, and contained within a housing, forming the hydrogen storage assembly 2010. Other methods of storing hydrogen may be used. The hydrogen storage assembly 2010 configured as the flat pack provides a storage volume 2012 above the hydrogen storage assembly 2010 for storing various objects, depending on the configuration and use of the vehicle 10. For example, the storage volume 2012 may be used for pickup and delivery applications (e.g., storing packages in the storage volume 2012). In some embodiments, other components and/or systems of the vehicle 10 may be positioned within the storage volume 2012 above the hydrogen storage assembly 2010.

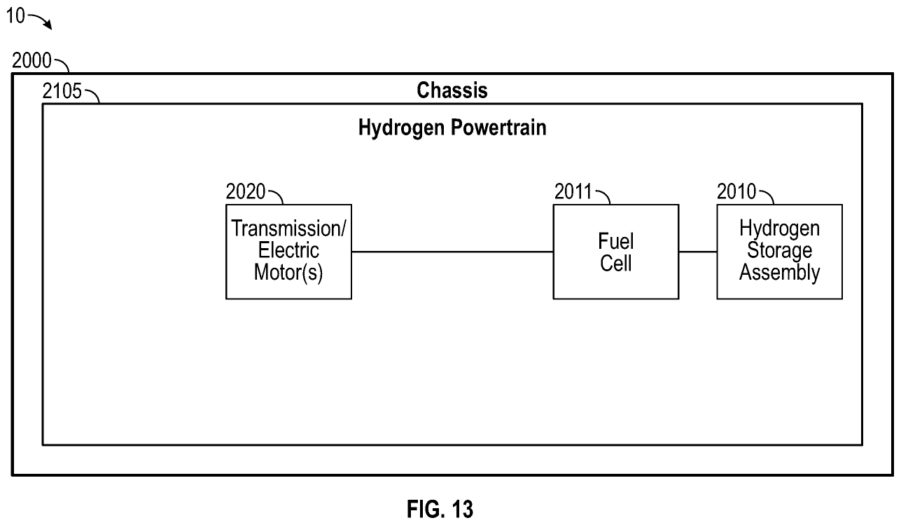

Referring to FIG. 13, the vehicle 10 includes a non-hybrid powertrain, shown as hydrogen powertrain 2105, where the hydrogen powertrain 2105 includes the transmission 2020, the hydrogen storage assembly 2010 and the hydrogen fuel cell 2011. The hydrogen powertrain 2105 is configured for the hydrogen fuel cell 2011 to convert hydrogen from the hydrogen storage assembly 2010 into electrical energy. The vehicle 10 further includes the transmission 2020 electrically coupled to the hydrogen fuel cell 2011 and configured to use electrical energy to power the vehicle 10 (e.g., via the motive driver). In some embodiments, the vehicle 10 further includes the prime mover 2050 configured as an electric motor for using electrical energy generated by the hydrogen fuel cell 2011 to power the vehicle 10.

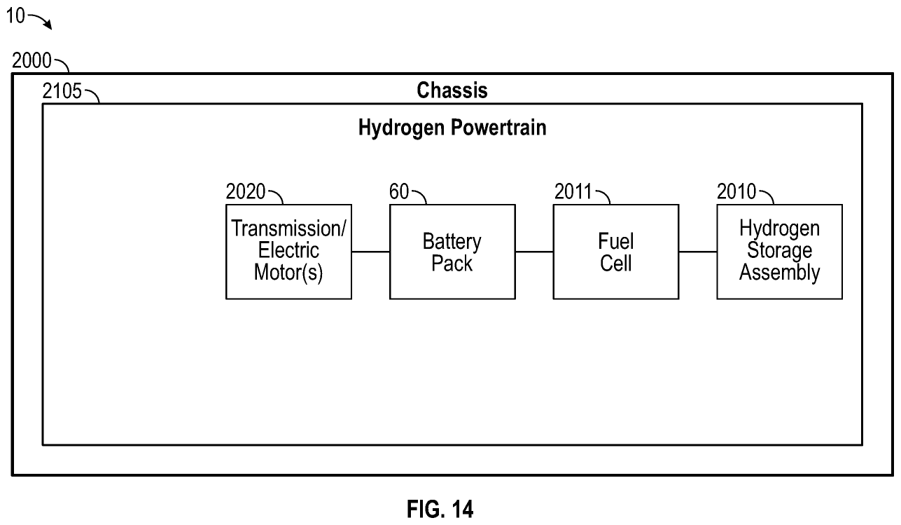

Referring to FIG. 14, the vehicle 10 includes the hydrogen powertrain 2105, where the hydrogen powertrain 2105 further includes the batteries 60. The batteries 60 may be electrically connected to the hydrogen fuel cell 2011. The vehicle 10 may be configured for the hydrogen fuel cell 2011 to charge the batteries 60, where the batteries 60 provide electrical energy for powering the vehicle 10. In some embodiments, the batteries 60 and the hydrogen fuel cell 2011 are positioned rearward from the hydrogen storage assembly 2010, where the batteries 60 and the hydrogen fuel cell 2011 may be variably positioned relative to each other (e.g., the hydrogen fuel cell 2011 may be positioned rearward of the batteries 60).

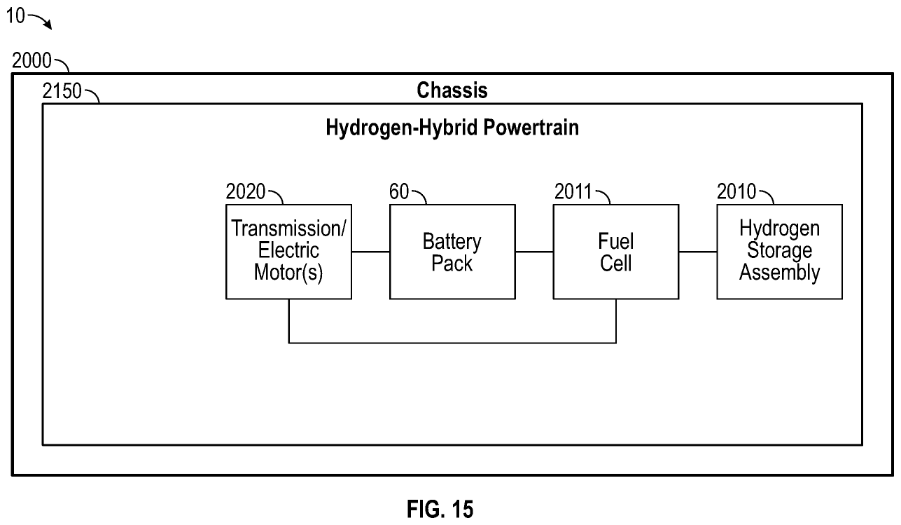

Referring to FIG. 15, the vehicle 10 includes the hybrid powertrain, shown as hydrogen-hybrid powertrain 2150, where the hydrogen-hybrid powertrain 2150 includes the transmission 2020, the batteries 60, the hydrogen fuel cell 2011, and the hydrogen storage assembly 2010. The batteries 60 may be externally charged (e.g., at a charging station), to store electrical energy on-board the vehicle 10. The transmission 2020 of the vehicle 10 may be configured to selectively use electrical energy from the hydrogen fuel cell 2011 to power the vehicle 10, and/or use electrical energy provided from the batteries 60 to power the vehicle 10.

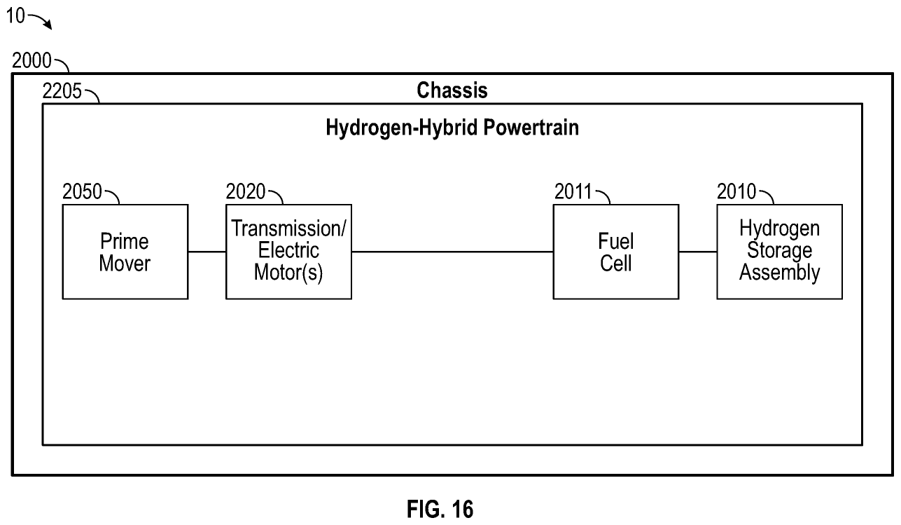

Referring to FIG. 16, the vehicle 10 includes the hybrid powertrain, shown as hydrogen-hybrid powertrain 2205, where the hydrogen-hybrid powertrain 2205 includes the transmission 2020, the prime mover 2050 configured as an engine, the hydrogen storage assembly 2010, and the hydrogen fuel cell 2011. The transmission 2020 may be configured to selectively use electrical energy generated by the hydrogen fuel cell 2011, and/or mechanical energy from the prime mover 2050 to power (e.g., drive) the vehicle 10.

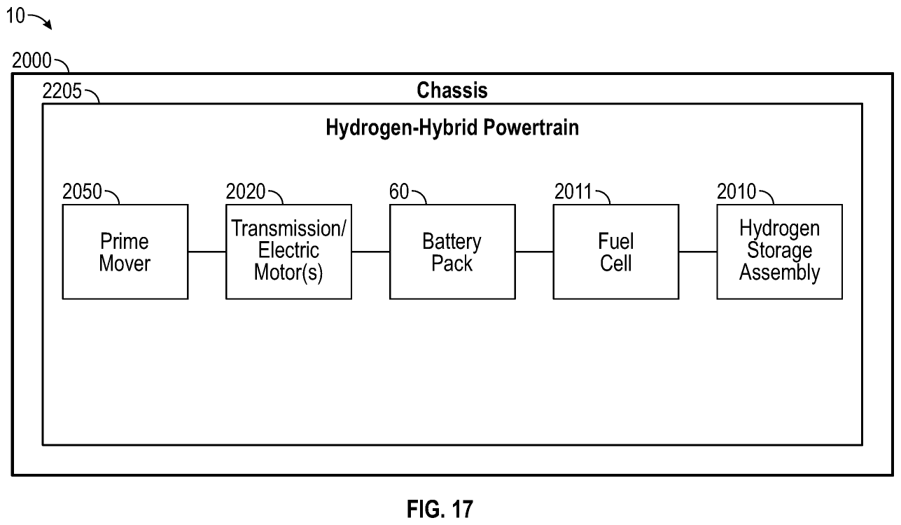

Referring to FIG. 17, the hydrogen-hybrid powertrain 2205 further includes the batteries 60. The vehicle 10 may be configured for the hydrogen fuel cell 2011 to charge the batteries 60, where the batteries 60 provide electrical energy for powering the vehicle 10. In some embodiments, the batteries 60, the hydrogen fuel cell 2011, and/or the prime mover 2050 are positioned rearward from the hydrogen storage assembly 2010, where the batteries 60, the hydrogen fuel cell 2011, and/or the prime mover 2050 may be variably positioned relative to each other.

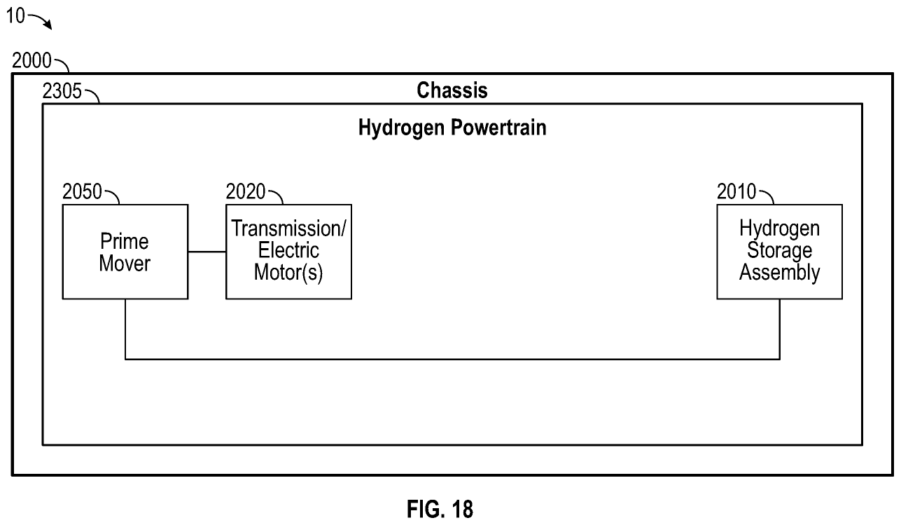

Referring to FIG. 18, the vehicle 10 includes the non-hybrid powertrain, shown as powertrain 2305, where the powertrain 2305 includes the transmission 2020, the prime mover 2050 configured as a hydrogen combustion engine, and the hydrogen storage assembly 2010. The powertrain 2305 is configured for hydrogen of the hydrogen storage assembly 2010 to be reacted (e.g., combusted) within the hydrogen combustion engine to create mechanical energy for powering the vehicle 10.

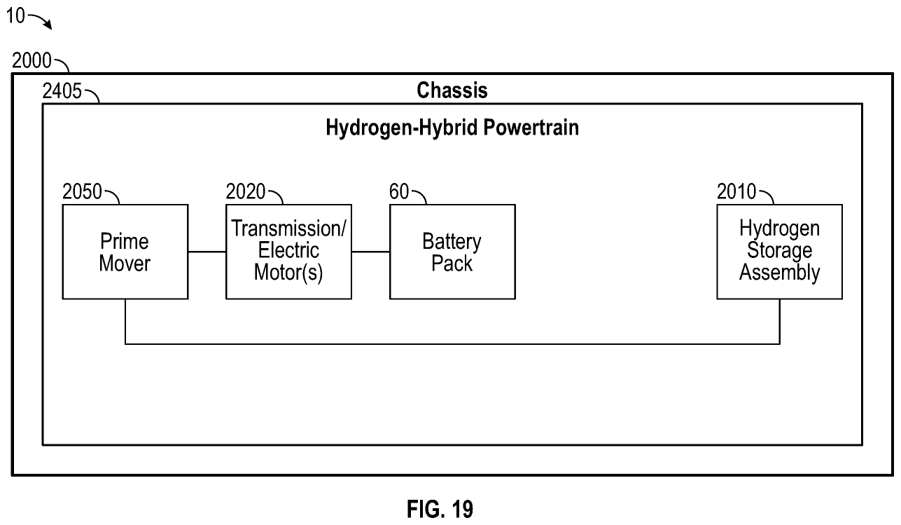

Referring to FIG. 19, the vehicle 10 includes the hybrid powertrain, shown as hydrogen-hybrid powertrain 2405, where the hydrogen-hybrid powertrain 2405 includes the powertrain 2305 (see FIG. 18), and the batteries 60. The batteries 60 may be eternally charged. The transmission 2020 may be configured to selectively use electrical energy provided by the batteries 60, and/or mechanical energy from the hydrogen combustion engine to power (e.g., drive) the vehicle 10. For example, the hydrogen-hybrid powertrain 2405 may be similar to a gasoline/electric hybrid powertrain (e.g., with an internal combustion engine), instead using the hydrogen combustion engine.

In some embodiments, when one of the hybrid powertrains is used, the vehicle 10 may include various modes for an operator to selectively choose an energy source (e.g., engine, hydrogen fuel cell 2011) for powering the vehicle 10. In some embodiments, the vehicle 10, and/or or a control system thereof, may be programmed to selectively use an energy source generated by the hybrid powertrain based on characteristics of actions to be completed by the vehicle 10 (e.g., distance to be covered, speed, duration of action, energy level, etc.).

In some embodiments, the control system of the vehicle 10 may include a controller, wherein the controller is programmed to autonomously control the vehicle 10. The control system may control the vehicle 10 using artificial intelligence based autonomous driving applications.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement the vehicles 10, the chassis 2000, and/or one of the powertrains as shown in the various exemplary embodiments is illustrative only. Additionally, any element disclosed in one embodiment may be incorporated or utilized with any other embodiment disclosed herein.

What is claimed is:

1. A vehicle comprising:
a chassis; and
a hydrogen-hybrid powertrain coupled to the chassis, the hydrogen-hybrid powertrain comprising:
a hydrogen storage assembly supported on the chassis;
a fuel cell connected to the hydrogen storage assembly; and one of:
an energy storage device supported on the chassis; or
a prime mover supported on the chassis and a transmission coupled to the prime mover;
wherein the hydrogen-hybrid powertrain selectively receives energy from one or more of the fuel cell, the energy storage device, or the prime mover to drive the vehicle.

2. The vehicle of claim 1, wherein the fuel cell is arranged between the hydrogen storage assembly and the prime mover.

3. The vehicle of claim 1, wherein the fuel cell is arranged between the hydrogen storage assembly and the energy storage device.

4. The vehicle of claim 1, wherein energy storage device is arranged between the fuel cell and the prime mover.

5. The vehicle of claim 1, wherein energy storage device is arranged between the hydrogen storage assembly and the prime mover.

6. The vehicle of claim 1, wherein the vehicle is a refuse vehicle.

7. The vehicle of claim 1, wherein the vehicle is a fire truck.

8. The vehicle of claim 1, wherein the vehicle is a concrete mixer truck.

9. The vehicle of claim 1, wherein the vehicle is a lift device.

10. The vehicle of claim 1, wherein the vehicle is a delivery vehicle.

11. The vehicle of claim 1, wherein the vehicle is a military vehicle.

12. The vehicle of claim 1, further comprising a transmission arranged between the prime mover and the energy storage device.

13. A vehicle comprising:
a chassis; and
a hydrogen-hybrid powertrain coupled to the chassis, the hydrogen-hybrid powertrain comprising:
a hydrogen storage assembly supported on the chassis;
a fuel cell connected to the hydrogen storage assembly supported on the chassis;
an energy storage device supported on the chassis; and
an electric motor coupled to the fuel cell, wherein the hydrogen-hybrid powertrain selectively receives energy from the fuel cell and the energy storage device.

14. The vehicle of claim 13, wherein the fuel cell is arranged between the hydrogen storage assembly and the energy storage device.

15. The vehicle of claim 13, wherein the vehicle is a refuse vehicle.

16. The vehicle of claim 13, wherein the vehicle is a concrete mixer truck.

17. The vehicle of claim 13, wherein the vehicle is a lift device, a delivery vehicle, or a military vehicle.

18. A vehicle comprising:
a chassis; and
a hydrogen-hybrid powertrain coupled to the chassis, the hydrogen-hybrid powertrain comprising:
a hydrogen storage assembly supported on the chassis;
a fuel cell connected to the hydrogen storage assembly supported on the chassis;
an internal combustion engine supported on the chassis; and
an electric motor coupled to the fuel cell, wherein the hydrogen-hybrid powertrain selectively receives energy from the fuel cell and the internal combustion engine.

19. The vehicle of claim 18, wherein the fuel cell is arranged between the hydrogen storage assembly and the internal combustion engine.

20. The vehicle of claim 18, wherein the vehicle is a refuse vehicle, a fire truck, lift device, a delivery vehicle, or a military vehicle.
